(19) United States
(12) Patent Application Publication
(10) Pub. No.: US 2019/0137773 A1
(43) Pub. Date: May 9, 2019

(54) DISPLAY DEVICE AND OPERATING METHOD THEREOF

(71) Applicant: BOE TECHNOLOGY GROUP CO., LTD., Beijing (CN)

(72) Inventors: Song SONG, Beijing (CN); Kazuyoshi NAGAYAMA, Beijing (CN)

(21) Appl. No.: 16/234,687

(22) Filed: Dec. 28, 2018

Related U.S. Application Data
(63) Continuation-in-part of application No. 15/104,644, filed on Jun. 15, 2016.

(30) Foreign Application Priority Data
Jul. 28, 2015 (CN) 201510451026.2

(51) Int. Cl. G02B 27/22; H04N 13/305

(52) U.S. Cl. CPC G02B 27/2214; H04N 13/305; G02B 27/225

(57) ABSTRACT

There is provided a display device, including a first display panel and a second display panel, the first display panel is flexibly connected with the second display panel, a light-exiting surface of the first display panel may be arranged to be directly adjacent to and face the first surface of the second display panel, the second pixel panel forms light-blocking regions and light-transmitting regions; the first display panel forms a left image for a left eye of a viewer and a right image for a right eye of the viewer, so that the left image is only seen by the left eye and the right image is only seen by the right eye through the light-blocking regions and the light-transmitting regions, the second display panel is capable of being folded to the first display panel along a second direction opposite to the first direction to perform a double-sided display.

### FIELD OF THE INVENTION

The present invention relates to the field of display technology, and particularly to a display device and an operating method thereof.

### BACKGROUND OF THE INVENTION

Main principle of 3D display technology is that a left eye and a right eye of a viewer receive different images respectively, and the viewer can perceive the levels of the images by analyzing and overlapping the image for left eye and the image for right eye in the viewer's brain so as to produce a stereoscopic sense.

### SUMMARY OF THE INVENTION

The present disclosure provides a display device including a first display panel and a second display panel, the first display panel is flexibly connected with the second display panel, the second display panel includes a first surface and a second surface which are opposite to each other, the first display panel includes a first pixel array, the second display panel includes a second pixel array, the first pixel array includes a plurality of first pixel units arranged regularly, each of the first pixel units includes a plurality of sub-pixels, the second pixel array includes a plurality of second pixel units arranged regularly, each of the second pixel units includes a plurality of sub-pixels, the second display panel is partially transparent, and the second display panel is capable of being folded to the first display panel along a first direction, so that a light-exiting surface of the first display panel is directly adjacent to and faces the first surface of the second display panel, and the second pixel array forms light-blocking regions and light-transmitting regions; and the first pixel array forms a left image for a left eye of a viewer and a right image for a right eye of the viewer, so that only the left image is seen by the left eye of the viewer and only the right image is seen by the right eye of the viewer through the light-blocking regions and the light-transmitting regions, and the second display panel is also capable of being folded to the first display panel along a second direction opposite to the first direction, so that a back surface of the first display panel opposite to the light-exiting surface is directly adjacent to and faces the second surface of the second display panel, so that the first display panel displays a first display picture and the second display panel displays a second display picture.

In some implementations, each of the first display panel and the second display panel is a liquid crystal display panel, and the display device further includes a double-sided illumination backlight, which is provided at the back surface of the first display panel.

In some implementations, the first display panel is a liquid crystal display panel, and the second display panel is an organic light emitting diode display panel, and the display device further includes a backlight provided at the back surface of the first display panel for providing backlight to the first display panel.

In some implementations, each of the first display panel and the second display panel is an organic light emitting diode display panel.

In some implementations, the display device further includes a backlight, which is provided at the back surface of the first display panel for providing backlight to the second display panel when the second display panel is folded to the first display panel along the second direction to perform a double-sided display.

In some implementations, the first display panel is an organic light emitting diode display panel, and the second display panel is a liquid crystal display panel, and the display device further includes a backlight, which is provided at the back surface of the first display panel for providing backlight to the second display panel when the second display panel is folded to the first display panel along the second direction to perform a double-sided display.

In some implementations, the first display panel and the second display panel are also capable of being arranged side by side, so that the first display panel transmits light of the backlight, and the second display panel transmits ambient light from the second surface side of the second display panel.

In some implementations, each of the light-exiting surface of the first display panel and the first surface of the second display panel is provided with a flexible transparent flat film, which is configured to form contact surfaces between the first display panel and the second display panel when the second display panel is folded to the first display panel along the first direction, so that light emitted from the first display panel radiates on the second display panel uniformly.

In some implementations, the display device further includes a sensor and a processor, the sensor and the processor are provided in a peripheral region of the second display panel, the sensor is configured to measure a distance between the left eye and the right eye of the viewer, and the processor is configured to adjust widths of the light-blocking regions based on the distance between the left eye and the right eye of the viewer and a preset width of each of the sub-pixels of the first pixel unit.

In some implementations, the processor is configured to adjust the widths of the light-blocking regions according to following light-blocking region adjusting formula:

$$c = \frac{4 pl}{p + l}$$

where c is the width of each of the light-blocking regions, p is the width of each of the sub-pixels of the first pixel unit, and l is the distance between the left eye and the right eye of the viewer.

In some implementations, the sensor includes a camera, when the light-exiting surface of the first display panel is provided to be directly adjacent to and face the first surface of the second display panel, the camera is rotated to be at the second surface, when a back surface of the first display panel opposite to the light exiting surface is provided to be directly adjacent to and face the second surface of the second display panel, the camera is rotated to be at the first surface.

The present disclosure provides an operating method of a display device, the display device includes a first display panel and a second display panel, the first display panel is flexibly coupled with the second display panel, the second display panel includes a first surface and a second surface which are opposite to each other, the first display panel includes a first pixel array, the second display panel includes a second pixel array, the first pixel array includes a plurality of first pixel units arranged regularly, each of the first pixel units includes a plurality of sub-pixels, the second pixel array includes a plurality of second pixel units arranged regularly, each of the second pixel units includes a plurality of sub-pixels, the second display panel is partially transparent, and the operating method includes: folding the second display panel to the first display panel along a first direction, so that a light-exiting surface of the first display panel is directly adjacent to and faces the first surface of the second display panel, and the second pixel array forms light-blocking regions and light-transmitting regions; causing the first pixel array to form a left image for a left eye of a viewer and a right image for a right eye of the viewer, so that only the left image is seen by the left eye of the viewer and only the right image is seen by the right eye of the viewer through the light-blocking regions and the light-transmitting regions; folding the second display panel to the first display panel along a second direction opposite to the first direction, so that a back surface of the first display panel opposite to the light-exiting surface of the first display panel is directly adjacent to and faces the second surface of the second display panel; and causing the first display panel to display a first display picture and the second display panel to display a second display picture.

### BRIEF DESCRIPTION OF THE DRAWINGS

FIG. 1 is a front view of a display device provided in a first embodiment of the present invention;

FIG. 2 is a rear view of the display device of FIG. 1;

FIG. 3 is a structural diagram of a first pixel array and a second pixel array in the first embodiment;

FIG. 4 is a front view of the display device shown in FIG. 1 which is folded along a first direction;

FIG. 5 is a rear view of the display device shown in FIG. 1 which is folded along the first direction;

FIG. 6 is a top view of the display device shown in FIG. 4 which is folded along the first direction;

FIG. 7 is a structural diagram of light-blocking regions and light-transmitting regions formed in the display device shown in FIG. 6;

FIG. 8 is a diagram illustrating the principle of 3D display preformed by the display device shown in FIG. 7;

FIG. 9 is a top view of another display device provided in the first embodiment of the present invention;

FIG. 10 is a front view of the display device shown in FIG. 1 which is folded along a second direction;

FIG. 11 is a rear view of the display device shown in FIG. 1 which is folded along the second direction;

FIG. 12 is a top view of the display device shown in FIG. 10 which is folded along the second direction; and

FIG. 13 is a light path diagram of the display device shown in FIG. 12 which is in a double-sided display state.

### DETAILED DESCRIPTION OF THE EMBODIMENTS

In order to make persons skilled in the art better understand the solutions of the present invention, the display device and the operating method thereof will be described below in detail in conjunction with the accompanying drawings.

At present, 3D display devices are mainly classified into two types, one type of 3D display devices requires to be viewed by wearing 3D glasses, and the other type of 3D display devices is naked-eye 3D display. Parallax barrier technology is a kind of naked-eye 3D technology, which, by means of a parallax barrier member, enables an image for a left eye to be seen only by the left eye and not to be seen by the right eye, meanwhile, an image for a right eye to be seen only by the right eye and not to be seen by the left eye, so that a picture for left eye and a picture for right eye are formed respectively, and a 3D picture is viewed finally. Therefore, it is required to add an extra parallax barrier member for an existing 3D display to realize 3D display. However, there is limitation to the existing display device realizing 3D display by means of the parallax barrier member, for example, since the parallax barrier member is fixed on the display panel, the display device can only display 3D image, and sizes and positions of the light-blocking regions (light-shielding regions) of the parallax barrier member are fixed and cannot be adapted to any distance between two eyes of each viewer and any distance from each viewer to the display to be self-adaptively adjusted to obtain optimum 3D display effect.

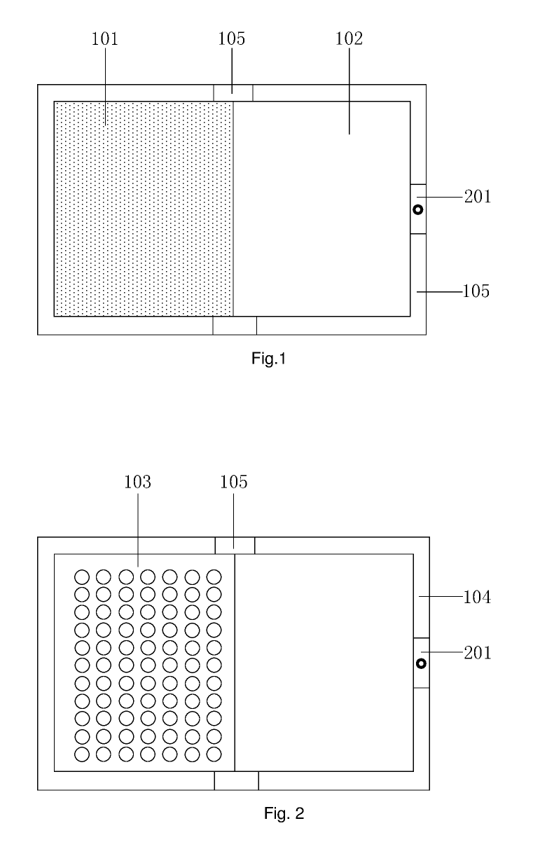

FIG. 1 is a front view of a display device provided in a first embodiment of the present invention, and FIG. 2 is a rear view of the display device of FIG. 1. As shown in FIG. 1 and FIG. 2, the display device comprises a first display panel 101, a second display panel 102 and a backlight 103, the first display panel 101 is flexibly connected with the second display panel 102, the first display panel 101 is provided at a light-exiting surface side of the backlight 103, the second display panel 102 comprises a first surface and a second surface which are provided opposite to each other, the second display panel 102 is a transparent display panel. As shown in FIG. 1, the first surface of the second display panel 102 is located at the front side of the display device, and the second surface of the second display panel 102 is located at the rear side of the display device. In the present embodiment, both the first display panel 101 and the second display panel 102 are liquid crystal display panels.

With reference to FIG. 1 and FIG. 2, the first display panel 101 and the second display panel 102 are arranged side by side, the first display panel 101 may transmit light of the backlight, and the second display panel 102 may transmit ambient light from a light-incoming surface side of the second display panel. Specifically, the second display panel 102 transmits ambient light from the rear side thereof, so that a viewer in front of the second display panel 102 can see the background behind the second display panel 102.

Optionally, a flexible circuit board is provided at a boundary region of the second display panel 102. Sides of the first display panel 101 and the second display panel 102 are provided with rigid frames 104, sides of a connecting portion between the first display panel 101 and the second display panel 102 are provided with flexible frames 105. Optionally, the backlight 103 includes a plurality of uniformly distributed light-emitting diodes. Preferably, the light-emitting diodes are white light-emitting diodes, brightness of which are adjustable.

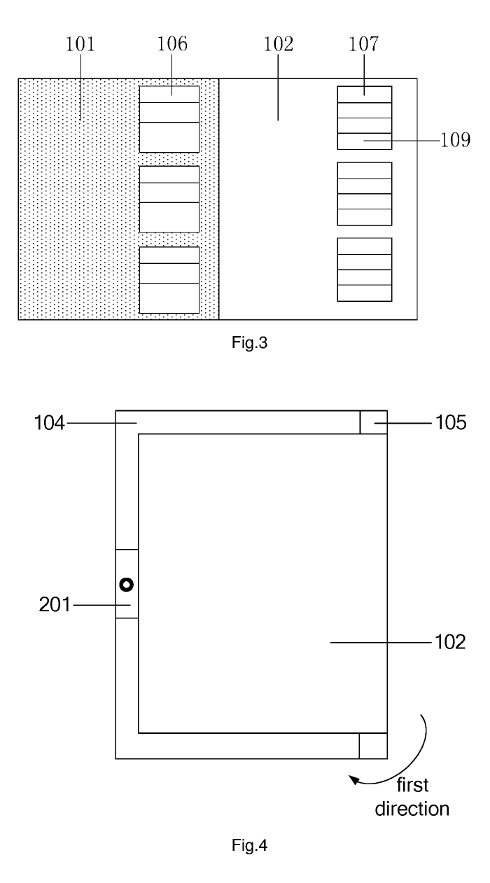

FIG. 3 is a structural diagram of a first pixel array and a second pixel array in the first display panel and the display panel shown in FIG. 1. As shown in FIG. 3, the first display panel 101 comprises a first pixel array 106, the second display panel 102 comprises a second pixel array 107, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels.

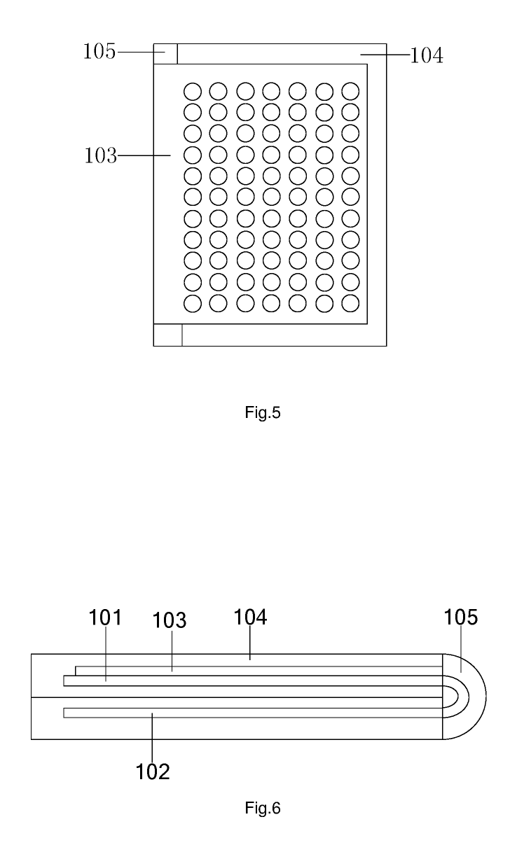

FIG. 4 is a front view of the display device shown in FIG. 1 which is folded along a first direction, FIG. 5 is a rear view of the display device shown in FIG. 1 which is folded along the first direction, and FIG. 6 is a top view of the display device shown in FIG. 1 which is folded along the first direction. The first direction is a direction in which the second display panel 102 is rotated clockwise to overlap with the first display panel 101 with a boundary between the first display panel 101 and the second display panel 102 as an axis. As shown in FIG. 4 to FIG. 6, when the first display panel 101 and the second display panel 102 are folded along the first direction, a light-exiting surface of the first display panel 101 is directly adjacent to and faces the first surface of the second display panel 102.

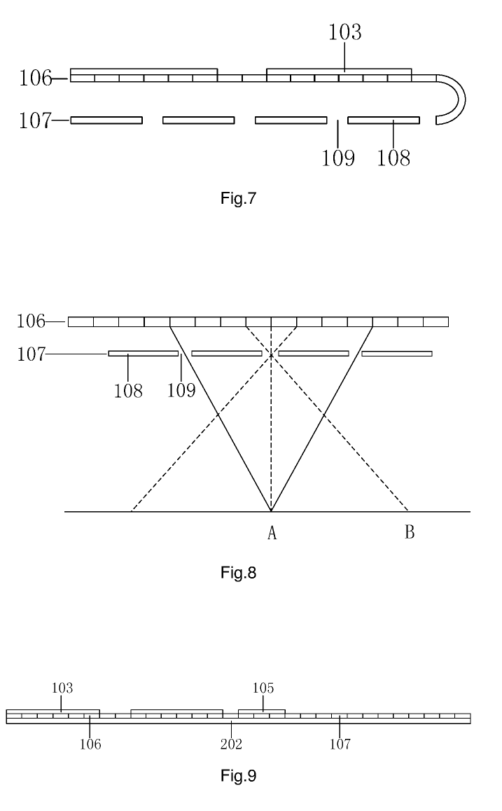

FIG. 7 is a structural diagram of light-blocking regions and light-transmitting regions formed in the display device shown in FIG. 6, and FIG. 8 is a diagram illustrating the principle of 3D display preformed by the display device shown in FIG. 7. As shown in FIG. 7 and FIG. 8, gray values of part of sub-pixels of the second pixel array 107 are set to zero, the part of sub-pixels display black to form light-blocking regions 108, at the same time, gray values of the other part of the sub-pixels of the second pixel array 107 are set to a maximum value so as to form light-transmitting regions 109. The formed light-blocking regions 108 and the light-transmitting regions 109 are shown in FIG. 7 and FIG. 8. By the light-blocking regions 108 and the light-transmitting regions 109, the left eye of the viewer can only see a left image for left eye formed on the first pixel array 106, and the right eye of the viewer can only see a right image for right eye formed on the first pixel array 106, thus autostereoscopic 3D display is realized.

In the present embodiment, the display device further comprises a sensor and a processor (not shown in figures), the sensor and the processor are provided in a peripheral region of the second display panel. The sensor measures a distance between the left eye and the right eye of the viewer, and the processor adjusts widths of the light-blocking regions, that is, the number of sub-pixels displaying black, based on the distance between eyes and a preset width of a sub-pixel of the first pixel unit. Preferably, the processor adjusts the widths of the light-blocking regions according to the following light-blocking region adjusting formula:

$$c = \frac{4 pl}{p + l}$$

where c is the width of the light-blocking region 108, p is the width of the sub-pixel of the first pixel unit in the first pixel array 106, and l is the distance between eyes of the viewer.

With reference to FIG. 8, point A is a position of the left eye, and point B is a position of the right eye, according to the similar triangle theorem, the following equations can be obtained:

$$\begin{matrix}\frac{h}{s} = \frac{p}{l} & ( 1 ) \\ \frac{c}{4 p} = \frac{s}{s + h} & ( 2 )\end{matrix}$$

where h is a distance between the first pixel array 106 and the second pixel array 107, s is a distance between the eyes and the second pixel array 107, p is a width of the sub-pixel in the first pixel array 106, l is the distance between the eyes, and c is a width of the light-blocking region 108. The light-blocking region adjusting formula may be obtained based on the equation (1) and the equation (2). The widths of the light-blocking regions may be adjusted by the above light-blocking region adjusting formula, so that 3D display performance of the display device can be improved. In addition, to facilitate the implementation, sub-pixels of the first pixel array 106 and sub-pixels of the second pixel array 107 in the present embodiment are the same in size.

FIG. 9 is a top view of another display device provided in an embodiment of the present invention. As shown in FIG. 9, light-exiting surface of the first display panel and the first surface of the second display panel are provided with a flexible transparent flat film 202, which is configured to form contact surfaces between the first display panel and the second display panel when the second display panel is folded to the first display panel as shown in FIG. 6, so that light emitted from the first display panel radiates on the second display panel uniformly, thus the quality of the displayed picture of the display device is improved.

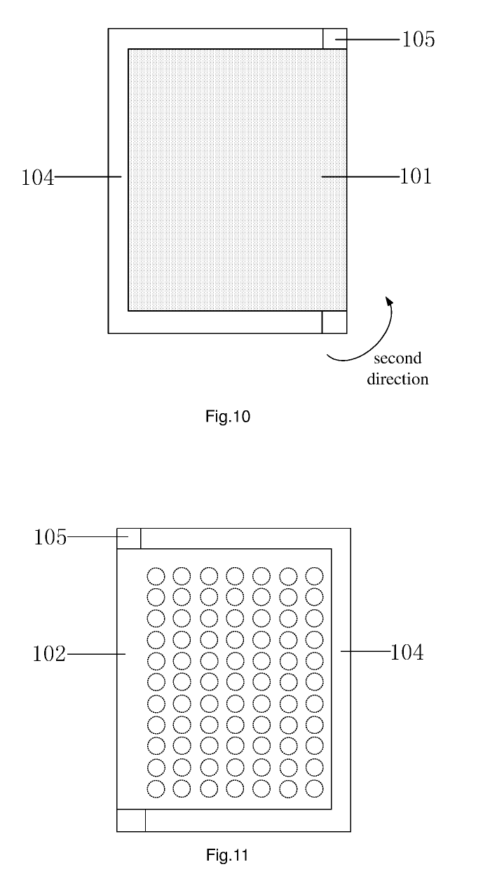

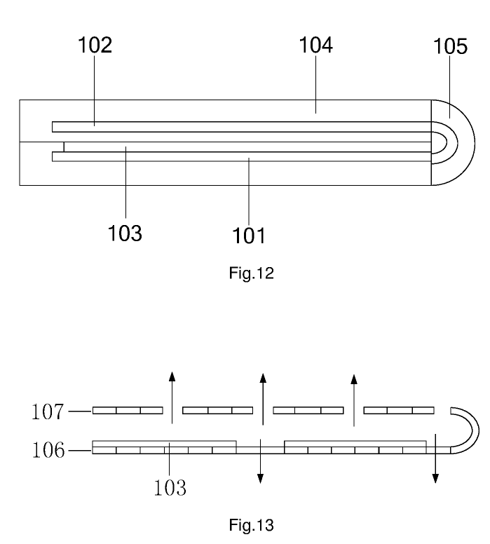

FIG. 10 is a front view of the display device shown in FIG. 1 which is folded along a second direction, FIG. 11 is a rear view of the display device shown in FIG. 1 which is folded along the second direction, and FIG. 12 is a top view of the display device shown in FIG. 10 which is folded along the second direction. As shown in FIG. 10 to FIG. 12, when the first display panel 101 and the second display panel 102 are folded in the second direction, light-incoming surface of the first display panel 101 faces the second surface of the second display panel 102. The first display panel 101 is configured to form a first display picture, the second display panel 102 is configured to form a second display picture, the first direction is contrary to the second direction, that is, the second direction is a direction in which the second display panel 102 is rotated anticlockwise to overlap with the first display panel 101 with a boundary between the first display panel 101 and the second display panel 102 as an axis.

FIG. 13 is a light path diagram of the display device shown in FIG. 12 which is in a double-sided display state. As shown in FIG. 13, the backlight 103 is a double-sided illumination backlight and is used to supply light to the first display panel 101 and the second display panel 102 after the first display panel 101 and the second display panel 102 are folded. Specifically, the backlight 103 can supply light for the first display panel 101, and can also supply light for the second display panel 102, so that the first display panel 101 may form the first display picture and the second display panel 102 may form the second display picture, thus a double-sided display function is realized. Optionally, the backlight 103 may be used as a lamp, or as a flash lamp when a camera operates. Optionally, the backlight 103 may be attached to the back surface of the first display panel 101.

With reference to FIG. 1 and FIG. 2, the sensor comprises a camera 201, when the light-exiting surface of the first display panel 101 is provided to face the first surface of the second display panel 102, the camera 201 is rotated to be at the second surface. When the light-incoming surface of the first display panel 101 is provided to face the second surface of the second display panel 102, the camera 201 is rotated to be at the first surface.

The display device provided in the present embodiment comprises a first display panel, a second display panel and a backlight, the first display panel is flexibly connected with the second display panel, the first display panel is provided at a light-exiting surface side of the backlight; when the light-exiting surface of the first display panel is arranged to be directly adjacent to and face the first surface of the second display panel, the second display panel forms light-blocking regions and light-transmitting regions. The first display panel forms a left image for a left eye of a viewer and a right image for a right eye of the viewer through the light-blocking regions and light-transmitting regions. The solution provided by the present embodiment can realize 3D display without adding an extra parallax barrier member.

Another embodiment of the present disclosure provides an operating method of the display device, wherein the display device comprises a first display panel, a second display panel and a backlight. As shown in FIG. 1 and FIG. 2, the first display panel 101 is flexibly connected with the second display panel 102, the first display panel 101 is provided at a light-exiting surface side of the backlight 103, and the second display panel 102 comprises a first surface and a second surface. With reference to FIG. 3, the first display panel 101 comprises a first pixel array 106, the second display panel 102 comprises a second pixel array 107, the first pixel array comprises a plurality of first pixel units arranged regularly, the first pixel unit comprises a plurality of sub-pixels, the second pixel array comprises a plurality of second pixel units arranged regularly, the second pixel unit comprises a plurality of sub-pixels.

The operating method comprises: when the first display panel and the second display panel are folded along the first direction, a light-exiting surface of the first display panel is directly adjacent to and faces the first surface of the second display panel, and the second pixel array forms light-blocking regions and light-transmitting regions. The first pixel array forms a left image for a left eye of a viewer and a right image for a right eye of the viewer by means of the light-blocking regions and the light-transmitting regions. The first direction is a direction in which the second display panel 102 is rotated clockwise to overlap with the first display panel 101 with a boundary between the first display panel 101 and the second display panel 102 as an axis.

With reference to FIG. 4 to FIG. 8, when the second display panel 102 is folded to the first display panel 101 along the first direction, the light-exiting surface of the first display panel 101 is directly adjacent to and faces the first surface of the second display panel 102. When gray values of sub-pixels of the second pixel array 107 are set to zero, the second pixel array forms the light-blocking regions and the light-transmitting regions, by means of which, the first pixel array 106 forms a left image for the left eye and a right image for the right eye, and thus 3D display can be realized without adding an extra parallax barrier member.

In the present embodiment, the operating method further comprises: when the first display panel and the second display panel are folded along the second direction, the light-incoming surface of the first display panel is directly adjacent to and faces the second surface of the second display panel, the first display panel forms a first display picture, and the second display panel forms a second display picture, the first direction is contrary to the second direction, that is, the second direction is a direction in which the second display panel 102 is rotated anticlockwise to overlap with the first display panel 101 with a boundary between the first display panel 101 and the second display panel 102 as an axis. With reference to FIG. 10 to FIG. 13, the backlight can not only supply light to the first display panel 101, but also supply light to the second display panel 102, so that the first display panel 101 forms the first display picture, and the second display panel 102 forms the second display picture, thus a double-sided display performance is realized.

In the present embodiment, the display device further comprises a sensor and a processor, the sensor and the processor are provided in a peripheral region of the second display panel. The operating method further comprises: the sensor measures a distance between the left eye and the right eye of the viewer; and the processor adjusts widths of the light-blocking regions based on the distance between eyes and a preset width of a sub-pixel of the first pixel array 106. Preferably, the step of the processor adjusts widths of the light-blocking regions based on the distance between eyes and a preset width of a sub-pixel of the first pixel unit comprises a step of: the processor adjusts the widths of the light-blocking regions according to the following light-blocking region adjusting formula:

$$c = \frac{4 pl}{p + l}$$

where c is the width of the light-blocking region 108, p is the width of the sub-pixel of the first pixel unit in the first pixel array 106, and l is the distance between eyes of the viewer.

With reference to FIG. 8, according to the similar triangle theorem, the following equations can be obtained:

$$\begin{matrix}\frac{h}{s} = \frac{p}{l} & ( 1 ) \\ \frac{c}{4 p} = \frac{s}{s + h} & ( 2 )\end{matrix}$$

where h is a distance between the first pixel array 106 and the second pixel array 107, s is a distance between the eyes and the second pixel array 107, p is a width of the sub-pixel in the first pixel array 106, l is the distance between the eyes, and c is a width of the light-blocking region 108. The light-blocking region adjusting formula may be obtained based on the equation (1) and the equation (2). The width of the light-blocking region may be adjusted by the above light-blocking region adjusting formula, so that 3D display performance of the display device can be improved.

Preferably, the sensor comprises a camera, and the operating method further comprises: when the light-exiting surface of the first display panel is provided to be directly adjacent to and face the first surface of the second display panel, the camera is rotated to be at the second surface; and when the light-incoming surface of the first display panel is provided to be directly adjacent to and face the second surface of the second display panel, the camera is rotated to be at the first surface.

The operating method of the display device provided in the present embodiment comprises: when the first display panel and the second display panel are folded along the first direction, the light-exiting surface of the first display panel is directly adjacent to and faces the first surface of the second display panel, the second pixel array forms light-blocking regions and light-transmitting regions. The first display panel forms a left image for a left eye of a viewer and a right image for a right eye of the viewer by means of the light-blocking regions and light-transmitting regions. The solution provided by the present embodiment can realize 3D display without adding an extra parallax barrier member.

Above description is described by taking both the first display panel 101 and the second display panel 102 being liquid crystal display panels as an example, but the present disclosure is not limited thereto. For example, in an embodiment, both the first display panel 101 and the second display panel 102 may be organic light emitting diode display panels (OLED display panels). In another embodiment, the first display panel 101 may be an OLED display panel, and the second display panel 102 may be a liquid crystal display panel. In a further embodiment, the first display panel 101 may be a liquid crystal display panel and the second display panel 102 may be an OLED display panel.

Specifically, in an embodiment, with reference to FIG. 1 to FIG. 13 again, the first display panel 101 may be a liquid crystal display panel, and the second display panel 102 may be an OLED display panel. In the present embodiment, the naked-eye 3D display as well as the double-sided display can also be achieved. Difference of the present embodiment from the embodiment in which both the first display panel 101 and the second display panel 102 are liquid crystal display panels is that, in the present embodiment, a transparent opening region is previously formed at a position of each pixel unit of the second display panel 102 where the light-transmitting region 109 is to be formed, that is, the light-transmitting region 109 is formed as the transparent opening region and is always transparent. In this way, when the second display panel 102 is folded along the first direction to be directly adjacent to and face the light-exiting surface of the first display panel 101, as shown in FIGS. 6-8, the pixel units of the second display panel 102, which is an OLED display panel, are in a dark state, thereby forming the light blocking regions 108. In this case, the effect of the naked-eye 3D display realized by the display device is the same as that of the embodiment in which both the first display panel 101 and the second display panel 102 are liquid crystal display panels. Other configurations of the display device and dimensions of the light-transmitting regions 109 in the present embodiment are the same as those of the embodiment in which both the first display panel 101 and the second display panel 102 are the liquid crystal display panels, which will not be described herein. In addition, in the present embodiment, since the backlight 103 is provided at the back surface of the first display panel 101, that is, the backlight 103 is attached to the back surface of the first display panel 101, when the second display panel 102 is folded to the first display panel 101 along the second direction to realize a double-sided display, as shown in FIG. 12, light emitted by the backlight 103 can pass through the light-transmitting regions 109 in the second display panel, thereby the second display panel 102 can perform RGBW display, therefore the display brightness is improved. In the implementation in which the double-sided display is performed, each of the pixel units in the second display panel 102 is one of a red sub-pixel R, a green sub-pixel G and a blue sub-pixel B, thereby performing a RGB color display, furthermore, since white light emitted from the backlight transmits through the light-transmitting regions 109, the light-transmitting regions 109 function as white sub-pixels W, thus the second display panel 102 can realize a RGBW display.

In another embodiment, with reference to FIGS. 1 through 13 again, both the first display panel 101 and the second display panel 102 may be OLED display panels. In the present embodiment, the naked-eye 3D display as well as the double-sided display can also be achieved. Difference of the present embodiment from the embodiment in which the first display panel 101 is a liquid crystal display panel and the second display panel 102 is an OLED display panel is that, in the present embodiment, both the first display panel 101 and the second display panel 102 are OLED display panels, and therefore, it is not necessary to provide a backlight, and both the first display panel 101 and the second display panel 102 can also perform display. Also, a transparent opening region is previously formed at a position of each pixel unit of the second display panel 102 where the light-transmitting region 109 is to be formed, that is, the light-transmitting region 109 is formed as a transparent opening region and is always transparent. In this way, when the second display panel 102 is folded along the first direction to be directly adjacent to and face the light-exiting surface of the first display panel 101, the pixel units of the second display panel 102, which is an OLED display panel, are in a dark state, thereby forming the light blocking regions 108. In this case, the naked-eye 3D display is realized. In addition, in a case where the second display panel 102 is folded to the first display panel 101 along the second direction, the display device in the present embodiment can perform double-sided display. Other configurations of the display device and dimensions of the light-transmitting regions 109 in the present embodiment are the same as those of the embodiment in which the first display panel 101 is a liquid crystal display panel and the second display panel 102 is an OLED display panel, and which are not described herein.

In the present embodiment, since both the first display panel 101 and the second display panel 102 are OLED display panels, the display device in the present embodiment can realize the naked-eye 3D display and double-sided display without providing the backlight 103.

Furthermore, in the display device according to another implementation of the present embodiment, the backlight 103 may still be provided at the back surface of the first display panel 101, thus when the second display panel 102 is folded to the first display panel 101 along the second direction, light emitted by the backlight 103 can pass through the light-transmitting regions 109 in the second display panel 102, thereby the second display panel 102 can perform the RGBW display, and the display brightness is improved.

In still another embodiment, the first display panel 101 may be an OLED display panel, and the second display panel 102 may be a liquid crystal display panel. In this embodiment, the naked-eye 3D display as well as the double-sided display can also be achieved. Difference of the present embodiment from the embodiment in which both the first display panel 101 and the second display panel 102 are liquid crystal display panels is that, in the present embodiment, the first display panel 101 is an OLED display panel. The display device in the present embodiment can also realize the naked-eye 3D display and the double-sided display. When the naked-eye 3D display is performed, the arrangement of the second display panel 102 is the same as that in the embodiment in which both the first display panel 101 and the second display panel 102 are liquid crystal display panels, and other configurations of the display device in the present embodiment are also the same as those in the embodiment in which both the first display panel 101 and the second display panel 102 are liquid crystal display panels, which will not be described again herein. In addition, since the backlight 103 is provided at the back surface of the first display panel 101 (that is, the backlight 103 is attached to the back surface of the first display panel 101) to provide a backlight for the second display panel 102 when performing the double-sided display, when the second display panel 102 is folded to the first display panel 101 along the second direction, the light emitted by the backlight 103 can pass through the light-transmitting regions 109 in the second display panel 102, thereby the second display panel 102 can perform the RGBW display, thus the display brightness is improved.

It can be understood that the foregoing implementations are merely exemplary embodiments for the purpose of explaining the principle of the present disclosure, but the present disclosure is not limited thereto. Various modifications and improvements can be made by those of ordinary skills in the art without departing from the spirit and essence of the present disclosure. These modifications and improvements shall also fall into the protection scope of the present disclosure.

What is claimed is:

1. A display device comprising a first display panel and a second display panel, the first display panel is flexibly connected with the second display panel, the second display panel comprises a first surface and a second surface which are opposite to each other, the first display panel comprises a first pixel array, the second display panel comprises a second pixel array, the first pixel array comprises a plurality of first pixel units arranged regularly, each of the first pixel units comprises a plurality of sub-pixels, the second pixel array comprises a plurality of second pixel units arranged regularly, each of the second pixel units comprises a plurality of sub-pixels, the second display panel is partially transparent, and wherein
the second display panel is capable of being folded to the first display panel along a first direction, so that a light-exiting surface of the first display panel is directly adjacent to and faces a first surface of the second display panel, and the second pixel array forms light-blocking regions and light-transmitting regions; and the first pixel array forms a left image for a left eye of a viewer and a right image for a right eye of the viewer, so that the left image is only seen by the left eye of the viewer and the right image is only seen by the right eye of the viewer through the light-blocking regions and the light-transmitting regions, and
the second display panel is also capable of being folded to the first display panel along a second direction opposite to the first direction, so that a back surface of the first display panel opposite to the light-exiting surface is directly adjacent to and faces the second surface of the second display panel, so that the first display panel displays a first display picture and the second display panel displays a second display picture.

2. The display device of claim 1, wherein each of the first display panel and the second display panel is a liquid crystal display panel, and
wherein the display device further comprises a double-sided illumination backlight, which is provided at the back surface of the first display panel.

3. The display device of claim 1, wherein the first display panel is a liquid crystal display panel, and the second display panel is an organic light emitting diode display panel, and
wherein the display device further comprises a backlight provided at the back surface of the first display panel for providing a backlight to the first display panel.

4. The display device of claim 1, wherein each of the first display panel and the second display panel is an organic light emitting diode display panel.

5. The display device of claim 4, wherein the display device further comprises a backlight, which is provided at the back surface of the first display panel for providing backlight to the second display panel when the second display panel is folded to the first display panel along the second direction to perform a double-sided display.

6. The display device of claim 1, wherein the first display panel is an organic light emitting diode display panel, and the second display panel is a liquid crystal display panel, and
wherein the display device further comprises a backlight, which is provided at the back surface of the first display panel for providing backlight to the second display panel when the second display panel is folded to the first display panel along the second direction to perform a double-sided display.

7. The display device of claim 2, wherein the first display panel and the second display panel are also capable of being arranged side by side, so that the first display panel transmits light of the backlight, and the second display panel transmits ambient light from the second surface side of the second display panel.

8. The display device of claim 1, wherein the light-exiting surface of the first display panel and the first surface of the second display panel are provided with a flexible transparent flat film, which is configured to form contact surfaces between the first display panel and the second display panel when the second display panel is folded to the first display panel along the first direction, so that light emitted from the first display panel radiates on the second display panel uniformly.

9. The display device of claim 1, further comprising a sensor and a processor, the sensor and the processor are provided in a peripheral region of the second display panel, wherein
the sensor is configured to measure a distance between the left eye and the right eye of the viewer, and
the processor is configured to adjust widths of the light-blocking regions based on the distance between the left eye and the right eye of the viewer and a preset width of each of the sub-pixels of the first pixel unit.

10. The display device of claim 9, wherein the processor is configured to adjust the widths of the light-blocking regions according to following light-blocking region adjusting formula:
$$c = \frac{4 pl}{p + l}$$
where c is the width of each of the light-blocking regions, p is the width of each of the sub-pixels of the first pixel unit, and l is the distance between the left eye and the right eye of the viewer.

11. The display device of claim 9, wherein the sensor comprises a camera, when the light-exiting surface of the first display panel is provided to be directly adjacent to and face the first surface of the second display panel, the camera is rotated to be at the second surface,
when the back surface of the first display panel opposite to the light exiting surface is provided to be directly adjacent to and face the second surface of the second display panel, the camera is rotated to be at the first surface.

12. An operating method of a display device, the display device comprises a first display panel and a second display panel, the first display panel is flexibly coupled with the second display panel, the second display panel comprises a first surface and a second surface which are opposite to each other, the first display panel comprises a first pixel array, the second display panel comprises a second pixel array, the first pixel array comprises a plurality of first pixel units arranged regularly, each of the first pixel units comprises a plurality of sub-pixels, the second pixel array comprises a plurality of second pixel units arranged regularly, each of the second pixel units comprises a plurality of sub-pixels, the second display panel is partially transparent, and the operating method comprises:
folding the second display panel to the first display panel along a first direction, so that a light-exiting surface of the first display panel is directly adjacent to and faces the first surface of the second display panel, and the second pixel array forms light-blocking regions and light-transmitting regions;
causing the first pixel array to form a left image for a left eye of a viewer and a right image for a right eye of the viewer, so that the left image is only seen by the left eye of the viewer and the right image is only seen by the right eye of the viewer through the light-blocking regions and the light-transmitting regions,
folding the second display panel to the first display panel along a second direction opposite to the first direction, so that a back surface of the first display panel opposite to the light-exiting surface of the first display panel is directly adjacent to and faces the second surface of the second display panel; and
causing the first display panel to display a first display picture and the second display panel to display a second display picture.

13. The operating method of the display device of claim 12, wherein each of the first display panel and the second display panel is a liquid crystal display panel, and
wherein the display device further comprises a double-sided illumination backlight, which is provided at the back surface of the first display panel.

14. The operating method of the display device of claim 12, wherein the first display panel is a liquid crystal display panel, and the second display panel is an organic light emitting diode display panel, and
wherein the display device further comprises a backlight provided at the back surface of the first display panel for providing a backlight to the first display panel.

15. The operating method of the display device of claim 12, wherein each of the first display panel and the second display panel is an organic light emitting diode display panel.

16. The operating method of the display device of claim 15, wherein the display device further comprises a backlight, which is provided at the back surface of the first display panel for providing backlight to the second display panel when the second display panel is folded to the first display panel along the second direction to perform a double-sided display.

17. The operating method of the display device of claim 12, wherein the first display panel is an organic light emitting diode display panel, and the second display panel is a liquid crystal display panel, and
wherein the display device further comprises a backlight, which is provided at the back surface of the first display panel for providing backlight to the second display panel when the second display panel is folded to the first display panel along the second direction to perform a double-sided display.
